(19) United States
(12) Patent Application Publication
(10) Pub. No.: US 2024/0166253 A1
(43) Pub. Date: May 23, 2024

(54) FOLDABLE TROLLEY

(71) Applicant: QINGDAO XINZHAN TOOLS CO.,LTD, Qingdao (CN)

(72) Inventor: Chao FENG, Qingdao (CN)

(21) Appl. No.: 18/424,396

(22) Filed: Jan. 26, 2024

(30) Foreign Application Priority Data
Dec. 11, 2023 (CN) 202323371627.1

(51) Int. Cl. B62B 3/02; B62B 5/06

(52) U.S. Cl. CPC B62B 3/02; B62B 5/064; B62B 5/067

(57) ABSTRACT

A foldable trolley, including a foldable frame, a first support rod, a second support rod hinged to the first support rod, a first rotating wheel and a second rotating wheel. The foldable frame includes a front side frame, a rear side frame, a first foldable bottom frame and a second foldable bottom frame. The first foldable bottom frame and the second foldable bottom frame can be folded and unfolded. The first support rod and the second support rod are located below the first foldable bottom frame and the second foldable bottom frame, and are configured for bearing the first foldable bottom frame and the second foldable bottom frame. The first rotating wheel is rotatably arranged at a bottom of the front side frame, and the second rotating wheel is rotatably arranged at a bottom of the rear side frame.

### CROSS-REFERENCE TO RELATED APPLICATIONS

This application claims the benefit of priority from Chinese Patent Application No. 202323371627.1, filed on Dec. 11, 2023. The content of the aforementioned application, including any intervening amendments made thereto, is incorporated herein by reference in its entirety.

### TECHNICAL FIELD

This application relates to carrying tools, and more particularly to a foldable trolley.

### BACKGROUND

A trolley is needed when camping or transferring things, and the trolley is often designed as foldable to reduce the space occupation.

However, the load-bearing capability of the existing foldable trolleys is poor, and the foldable part of the foldable trolley may be dented or damaged after subjected to long-term load bearing.

### SUMMARY

Hence, a main purpose of the present disclosure is to provide a foldable trolley with good load-bearing capacity.

In order to achieve the above purpose, the following technical solutions are adopted.

This application provides a foldable trolley, comprising:
a foldable frame; comprising a front side frame, a rear side frame, a first foldable bottom frame and a second foldable bottom frame, the first foldable bottom frame is hinged with the second foldable bottom frame, the front side frame is arranged at an end of the first foldable bottom frame which is away from the second foldable bottom frame, the rear side frame is arranged at an end of the second foldable bottom frame which is away from the first foldable bottom frame, the first foldable bottom frame is hinged with the front side frame, and the second foldable bottom frame is hinged with the rear side frame, the first foldable bottom frame and the second foldable bottom frame are able to be folded or unfolded;
a first support rod and a second support rod are hinged together, an end of the first support rod which is away from the second support rod is rotatably connected with the front side frame, an end of the second support rod which is away from the first support rod is rotatably connected with the rear side frame, the first support rod and the second support rod are located beneath the first foldable bottom frame and the second foldable bottom frame, and the first support rod and the second support rod are used for load bearing the first foldable bottom frame and the second foldable bottom frame;
a first rotating wheel is rotatably arranged at the bottom of the front side frame; and
a second rotating wheel is rotatably arranged at the bottom of the rear side frame.

In some embodiments, an axis of a hinged connection between the first support rod and the second support rod is perpendicular to the first foldable bottom frame in an unfolded configuration.

In some embodiments, an end of the first support rod which is away from the second support rod is provided with a first sleeve, the first sleeve is rotatably sleeved on the front side frame, an end of the second support rod which is away from the first support rod is provided with a second sleeve, and the second sleeve is rotatably sleeved on the rear side frame.

In some embodiments, a top of the first support rod is provided with a first bearing block, a top of the second support rod is provided with a second bearing block, and the first bearing block and the second bearing block are configured for bearing the first foldable bottom frame and the second foldable bottom frame.

In some embodiments, two first convex pieces are arranged spaced apart on the top of the first bearing block, the first foldable bottom frame is provided with a first locating rod, and the first locating rod is configured to be clamped between the two first convex pieces when the first foldable bottom frame is unfolded with respect to the second foldable bottom frame; and/or two second convex pieces are arranged spaced apart on a top of the second bearing block, the second foldable bottom frame is provided with a second locating rod, and the second locating rod is configured to be clamped between the two second convex pieces when the first foldable bottom frame is unfolded with respect to the second foldable bottom frame.

In some embodiments, the front side frame includes front upper frame and a front lower frame which are detachably connected, the first support rod is rotatably connected with the front lower frame; the rear side frame includes a rear upper frame and a rear lower frame which are detachably connected, and the second support rod is rotatably connected with the rear lower frame.

In some embodiments, the front upper frame includes a first top rod and two first vertical rods which are arranged spaced apart beneath the first top rod; the front lower frame includes a first bottom rod and two first vertical pipes which are arranged spaced apart above the first bottom rod, and the two first vertical rods are configured to be detachably inserted into the two first vertical pipes, so as to achieve the detachable connection between the front upper frame and the front lower frame, and rotatably connection between the first support rod and the first vertical pipe; and
the rear upper frame includes a second top rod and two second vertical rods; the two second vertical rods are arranged spaced apart beneath the second top rod; the rear lower frame includes a second bottom rod and two second vertical pipes which are arranged spaced apart above the second bottom rod, and the two second vertical rods are configured to be detachably inserted into the two second vertical pipes, so as to achieve the detachable connection between the rear upper frame and the rear lower frame, and the rotatably connection between the second support rod and the second vertical pipe.

In some embodiments, the foldable trolley further includes a handle assembly, and the handle assembly is rotatably connected with the front side frame or the rear side frame.

In some embodiments, the handle assembly is capable of telescoping along its own axis.

In some embodiments, the handle assembly includes a handle, a first rod component and a second rod component; the first rod component and the second rod component are sleevedly connected; the handle is arranged on the first rod component; the second rod component is rotatably connected with the front side frame or the rear side frame; and the first rod component is configured to move along its own axial direction to change a length of the first rod component sleeved in the second rod component.

In some embodiments, the number of the first rotating wheels is two, and the two first rotating wheels are rotatably arranged spaced apart at the bottom of the front side frame; the number of the second rotating wheels is two, and the two second rotating wheels is rotatably arranged spaced apart at the bottom of the rear side frame.

Compared to the prior art, this application has the following beneficial effects.

In the practical application (e.g., for camping), it is only required to push the foldable trolley frame to drive the first rotating wheel and the second rotating wheel to rotate, so as to make the movement of the foldable trolley. When the foldable trolley is required to be transported or stored, the first foldable bottom frame is folded with the second foldable bottom frame, thereby saving the occupied space of the foldable trolley. Specifically, when folding, the hinge joint between the first foldable bottom frame and the second foldable bottom frame are lifted upward, and both of the front and the rear of the first foldable bottom frame and the second foldable bottom frame are rotated to enable the folding of the first foldable bottom frame and the second foldable bottom frame. At the same time, both of the front and the rear of the first support rod and the second support rod are also rotated, such that the first support rod and the second support rod are folded as well. After folding, the first foldable bottom frame and the second foldable bottom frame are also substantially in the upright state, resulting in small spaces among the front side frame, the first foldable bottom frame, the second foldable bottom frame and the rear end side frame, or making them overlapped together after folding. At this time, the space between the front side frame and the rear side frame is decreased greatly. The front side frame and the rear side frame can be directly pulled away from each other to meet the requirement of unfolding the first foldable bottom frame and the second foldable bottom frame. Due to the additionally arrangement of the first support rod and the second support rod beneath the first foldable bottom frame and the second foldable bottom frame in the present disclosure, the first support rod and the second support rod function as a load bearing structure for the first foldable bottom frame and the second foldable bottom frame. Moreover, the first support rod and the second support rod can support the articles placed on the first foldable bottom frame and the second foldable bottom frame together with the first foldable bottom frame and the second foldable bottom frame, and thus significantly increasing the load-bearing capacity of the foldable trolley.

### BRIEF DESCRIPTION OF THE DRAWINGS

In order to illustrate the technical solutions in the embodiments of the present disclosure or the technical solutions in the prior art more clearly, the drawings required in the description of the embodiments or prior art will be briefly introduced below. It is obvious that the drawings described in the following are only some embodiments of the present disclosure, and for those skilled in the art, other drawings can also be obtained according to the drawing without making any creative effort.

FIG. 1 schematically illustrates a structure of a foldable trolley according to an embodiment of the present disclosure in an unfolded configuration;

FIG. 2 schematically illustrates the structure of the foldable trolley according to an embodiment of the present disclosure in a folded configuration;

FIG. 3 schematically illustrates the structure of the foldable trolley according to an embodiment of the present disclosure in the absence of the first foldable bottom frame, the second foldable bottom frame and the handle assembly;

FIG. 4 is an enlarged view of part A in FIG. 3;

FIG. 5 schematically illustrates the first foldable bottom frame and the second foldable bottom frame according to an embodiment of the present disclosure;

FIG. 6 is a bottom view of the first foldable bottom frame and the second foldable bottom frame according to an embodiment of the present disclosure; and

FIG. 7 is an enlarged view of part B in FIG. 6.

In the drawings: 100-foldable frame; 110-front side frame; 111-front upper frame; 1111-first top rod; 11111-clamping component; 1112-first vertical rod; 112-front lower frame; 1121-first bottom rod; 1122-first vertical pipe; 120-rear side frame; 121-rear upper frame; 1211-second top rod; 1212-second vertical rod; 122-rear lower frame; 1221-second bottom rod; 1222-second vertical pipe; 130-first foldable bottom frame; 131-first locating rod; 132-first lug; 140-second foldable bottom frame; 141-second locating rod; 142-second lug; 150-first hinge component; 200-first support rod; 210-first sleeve; 220-first hinge portion; 230 first bearing block; 231-first convex piece; 300-second support rod; 310-second sleeve; 320-second hinge portion; 330-second bearing block; 331-second convex piece; 400-first rotating wheel; 500-second rotating wheel; 600-second hinge component; 700-handle assembly; 710-handle; 720-first rod component; 730-second rod component; 800-rotating wheel mounting component; and 900-connecting column.

The realization of the purpose, functional characteristics and advantages of the present disclosure will be further illustrated below in combination with the embodiments and the drawings.

### DETAILED DESCRIPTION OF EMBODIMENTS

The technical solutions in the embodiments of the present disclosure will be illustrated in detail in combination with the embodiments and the drawings. Obviously, the described embodiments are merely some of the embodiments of the present disclosure, instead of all embodiments of the present disclosure. According to the embodiments in the present disclosure, all other embodiments obtained by a person skilled in the art without making creative effort shall fall within the scope of the present disclosure.

It should be noted that all directional indications in the embodiment of the present disclosure (such as up, down, left, right, front and rear) are only used to explain the relative position relationship and movement between the parts under a specific posture (as shown in the drawing), and if the specific posture changes, the directional indication will change accordingly. In addition, terms such as “first”, “second”, etc., are for descriptive purposes only, and should not be construed as indicating or implying their relative importance or implying the number of technical features indicated. Thus, terms “first” and “second” may explicitly or implicitly indicate the presence of at least one of those elements referred to. Moreover, the “and/or” in the context includes three schemes, for example, the “A and/or B” includes technical solution A, technical solution B, and a combination thereof. Furthermore, the technical solutions among various embodiments may be combined with each other, but they must be based on those which can be achieved by a person skilled in the art, and when the combination of technical solutions is contradictory or impossible to achieve, it shall be deemed that such a combination does not exist, and is not within the scope of the present disclosure.

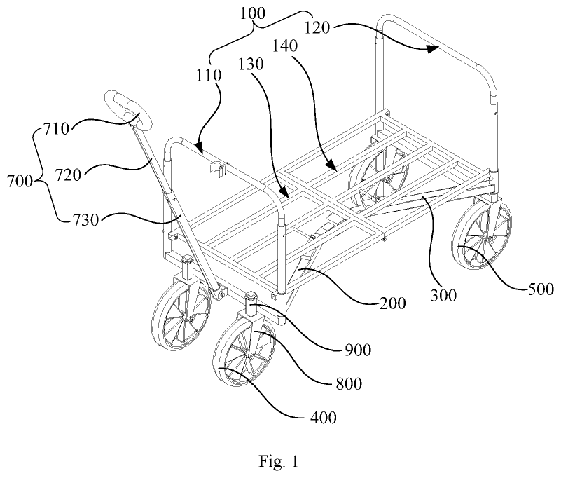

As shown in FIGS. 1-3, the present disclosure provides a foldable trolley, which includes a foldable frame 100, a first support rod 200, a second support rod 300 hinged with the first support rod 200, a first rotating wheel 400 and a second rotating wheel 500. The foldable frame 100 includes a front side frame 110, a rear side frame 120, a first foldable bottom frame 130 and a second foldable bottom frame 140. The first foldable bottom frame 130 is hinged with the second foldable bottom frame 140. The front side frame 110 is arranged at an end of the first foldable bottom frame 130 which is away from the second foldable bottom frame 140. the rear side frame 120 is arranged at an end of the second foldable bottom frame 140 which is away from the first foldable bottom frame 130, the first foldable bottom frame 130 is hinged with the front side frame 110, the second foldable bottom frame 140 is hinged with the rear side frame 120, and the first foldable bottom frame 130 and the second foldable bottom frame 140 can be folded or unfolded, an end of the first support rod 200 which is away from the second support rod 300 is rotatably connected with the front side frame 110, an end of the second support rod 300 which is away from the first support rod 200 is rotatably connected with the rear side frame 120, the first support rod 200 and the second support rod 300 are located beneath the first foldable bottom frame 130 and the second foldable bottom frame 140, and the first support rod 200 and the second support rod 300 are used for bearing the first foldable bottom frame 130 and the second foldable bottom frame 140, the first rotating wheel 400 is rotatably arranged at the bottom of the front side frame 110, and the second rotating wheel 500 is rotatably arranged at the bottom of the rear side frame 120.

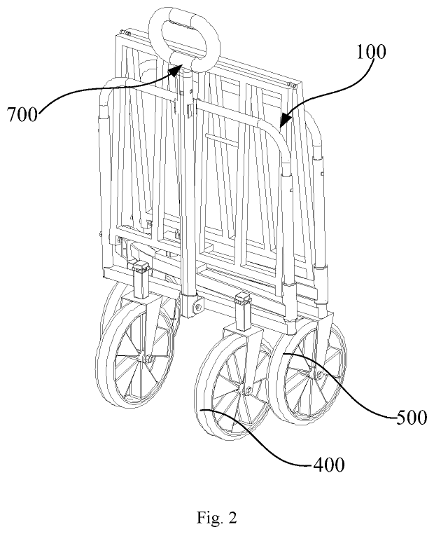

For camping or other purposes, the first rotating wheel 400 and the second rotating wheel 500 are rotated by directly pushing the foldable trolley frame 100 when needed the foldable trolley to make the movement of the foldable trolley. When the foldable trolley is required to transported or stored, the first foldable bottom frame 130 is folded with the second foldable bottom frame 140, thereby saving the occupied space of the foldable trolley, and specifically, when folding, the hinge joint of the first foldable bottom frame 130 and the second foldable bottom frame 140 are lifted upward, both of the front and the rear of the first foldable bottom frame 130 and the second foldable bottom frame 140 are rotated to enable the folding of the first foldable bottom frame 130 and the second foldable bottom frame 140, both of the front and the rear of the first support rod 200 and the second support rod 300 are also rotated when folding to enable the folding of the first support rod 200 and the second support rod 300 as well. After folding, the first foldable bottom frame 130 and the second foldable bottom frame 140 are also substantially in the upright state, resulting in small spaces among the front side frame 110, the first foldable bottom frame 130, the second foldable bottom frame 140 and the rear side frame 120 or making them overlapped together. After folding, the space between the front side frame 110 and the rear side frame 120 is decreased greatly, and the foldable trolley in folded configuration is shown in FIG. 2. The front side frame 110 and the rear side frame 120 can be directly pulled away from each other to meet the requirement of unfolding the first foldable bottom frame 130 and the second foldable bottom frame 140. As a first support rod 200 and a second support rod 300 are additionally arranged beneath the first foldable bottom frame 130 and the second foldable bottom frame 140 in the present disclosure, the first support rod 200 and the second support rod 300 function as a load bearing structure for the first foldable bottom frame 130 and the second foldable bottom frame 140. Moreover, the first support rod 200 and the second support rod 300 can support the articles placed on the first foldable bottom frame 130 and the second foldable bottom frame 140 together with the first foldable bottom frame 130 and the second foldable bottom frame 140, and thus significantly increasing the bearing capacity of the foldable trolley.

In the present embodiment, an axis of a hinged connection between the first foldable bottom frame 130 and the second foldable bottom frame 140 is parallel to the first foldable bottom frame 130, that is, when the foldable trolley is placed on the ground in the unfolded configuration, an axis of a hinged connection between the first foldable bottom frame 130 and the second foldable bottom frame 140 is parallel to the horizontal plane, as a result the hinge joint of the first foldable bottom frame 130 and the second foldable bottom frame 140 are lifted upward, and both of the front and the rear of the first foldable bottom frame 130 and the second foldable bottom frame 140 are rotated to enable the folding of the first foldable bottom frame 130 and the second foldable bottom frame 140.

Referring to FIG. 1 and FIGS. 5-7, the foldable frame 100 includes a first hinge component 150, and the first hinge component 150 passes through the first foldable bottom frame 130 and the second foldable bottom frame 140 orderly to achieve the hinge between the first foldable bottom frame 130 and the second foldable bottom frame 140.

Referring to FIG. 1 and FIGS. 5-7, the first hinge component 150 is located at the bottom of the first foldable bottom frame 130 and the second foldable bottom frame 140 to ensure the capacity of folding upwards of the first foldable bottom frame 130 and the second foldable bottom frame 140 when they are subjected to upward force at the hinge. The extrusion interference is generated on the opposite lateral of the first foldable bottom frame 130 and the second foldable bottom frame 140 when they are subjected to a downward force at their hinged area, and thus the first foldable bottom frame 130 and the second foldable bottom frame 140 will not be dented or folded downward. The above arrangement also makes the first foldable bottom frame 130 and the second foldable bottom frame 140 have a more reliable load-bearing capacity, such that they can bear a larger load.

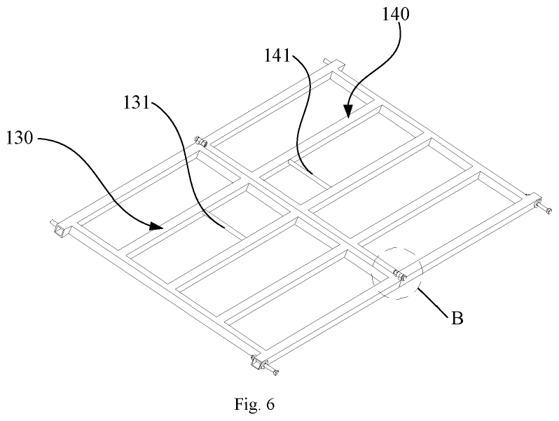

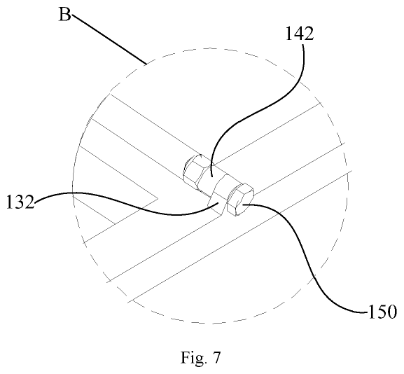

Referring to FIGS. 6-7, a first lug 132 is arranged at the bottom of the first foldable bottom frame 130, and a second lug 142 is arranged at the bottom of the second foldable bottom frame 140, and the first hinge component 150 passes through the first lug 132 and the second lug 142 to achieve the hinge between the first foldable bottom frame 130 and the second foldable bottom frame 140.

Furthermore, referring to FIGS. 6-7, the number of the first lug 132 is two or more, and the number of the second lug 142 is the same as the number of the first lug 132. The first lugs 132 are in one-to-one correspondence with the second lugs 142. The number of the first hinge component 150 is also the same as the number of the first lug 132, and the first lugs 132 are in one-to-one correspondence with the first hinge components 150. The first hinge components 150 are correspondingly matched with the first lugs 132 and the second lugs 142 to enable the reliable and stable hinged connection between the first foldable bottom frame 130 and the second foldable bottom frame 140. In the present embodiment, the number of the first lugs 132 is two, and two first lugs 132 are arranged spaced apart at the bottom of the first foldable bottom frame 130.

Referring to FIG. 1, the foldable frame 100 does not have the left and right side panels or the left and right side frames. Specifically, due to the arrangement of a first support rod 200 and a second support rod 300 in the present disclosure, the foldable trolley of the present disclosure can provide sufficient load-bearing capacity, so it is not necessary to introduce reinforcing structures such as left and right lateral panels or reinforcing ribs to enhance the load-bearing capacity of the foldable trolley. Moreover, the accommodating space of the foldable trolley is larger without left and right side panels or side frames, and thus items with a width greater than that of the foldable trolley can be placed, improving the applicability of the foldable trolley.

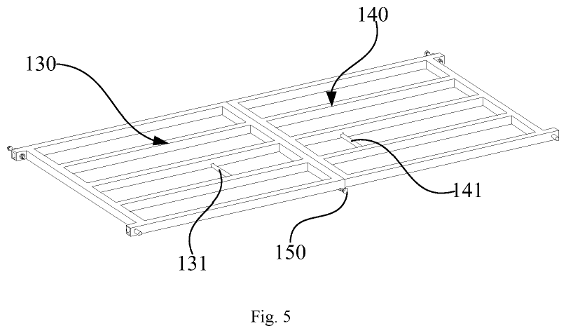

Referring to FIG. 1 and FIG. 5, the first foldable bottom frame 130 and the second foldable bottom frame 140 are frame components of a roughly rectangular shape which are produced by welding and fixing with a plurality of rods. Relative to the integral panel component, the first foldable bottom frame 130 and the second foldable bottom frame 140 of the trolley disclosed herein have less material consumption and light weight.

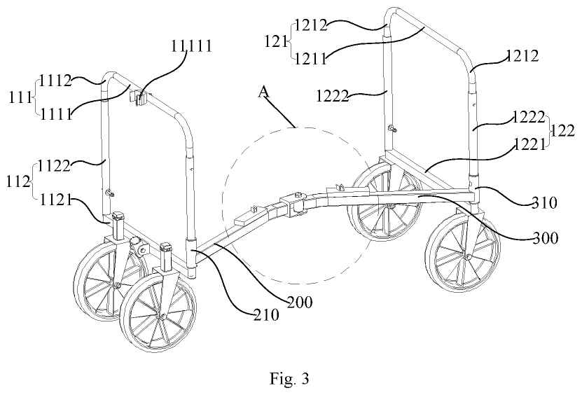

Referring to FIG. 3, the first support rod 200 and the second support rod 300 have a curved shape, so that the first support rod 200 and the second support rod 300 have a larger support area compared to a straight rod, and can provide a greater load-bearing capacity.

Referring to FIGS. 1-4, an axis of a hinged connection between the first support rod 200 and the second support rod 300 is perpendicular to the first foldable bottom frame 130 in an unfolded configuration. When the foldable trolley is unfolded and placed on the ground, the first foldable bottom frame 130 and the second foldable bottom frame 140 are parallel to the horizontal direction, which allows the perpendicularity of an axis of a hinged connection between the first support rod 200 and the second support rod 300 to the horizontal direction (i.e., an axis of a hinged connection between the first support rod 200 and the second support rod 300 is along the vertical direction).

Specifically, when the first foldable bottom frame 130 and the second foldable bottom frame 140 are folded upward, the first support rod 200 and the second support rod 300 are folded in the horizontal direction. Thus, when the foldable trolley bears the load, the direction (vertical direction) of the force that the first support rod 200 and the second support rod 300 are subjected to is different from that (vertical direction) of an axis of a hinged connection between the first support rod 200 and the second support rod 300, as a result, the first support rod 200 is away from the second support rod 300 to avoid them from folding caused by the effects of the load bearing. If an axis of a hinged connection between the first support rod 200 and the second support rod 300 is parallel to an axis of a hinged connection between the first foldable bottom frame 130 and the second foldable bottom frame 140 (i.e., both are horizontal direction), and then, the first foldable bottom frame 130 and the second foldable bottom frame 140 as well as the first support rod 200 and the second support rod 300 will be dented downward synchronously when they are bearing the load, which decrease the bearing capacity of the first support rod 200 and the second support rod 300 to small and thus making them more easily be damaged.

Referring to FIGS. 1-3, an end of the first support rod 200 away from the second support rod 300 has a first sleeve 210, and the first sleeve 210 is rotatably sleeved in the front side frame 110, so that the first support rod is rotatably connected with the front side frame 110. An end of the second support rod 300 which is away from the first support rod 200 has a second sleeve 310, and the second sleeve 310 is rotatably sleeved in the rear side frame 120, so that the second support rod is rotatably connected with the rear side frame 120.

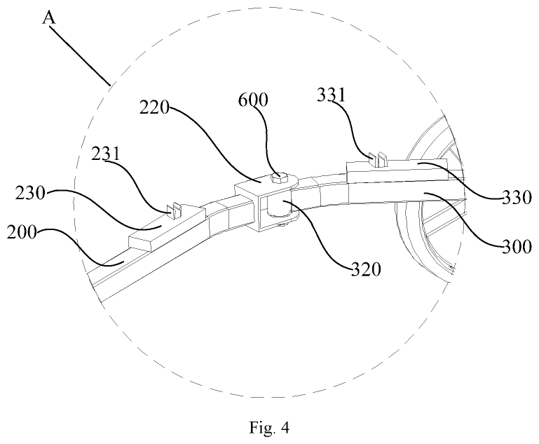

Referring to FIGS. 3-4, the foldable trolley further includes a second hinge component 600, which passes through the first support rod 200 and the second support rod 300 orderly to achieve the hinge between the first support rod 200 and the second support rod 300. Specifically, the axis of the second hinge component 600 is perpendicular to the first foldable bottom frame 130 in an unfolded configuration, and the axis of the second hinge component 600 is an axis of a hinged connection between the first support rod 200 and the second support rod 300.

Referring to FIGS. 3-4, an end of the first support rod 200 away from the second support rod 300 has a first hinge portion 220, and an end of the second support rod 300 which is away from the first support rod 200 has a second hinge portion 320, and the second hinge component 600 passes through the first hinge portion 220 and the second hinge portion 320 sequentially to achieve the hinged connection between the first support rod 200 and the second support rod 300.

Referring to FIGS. 3-4, the first hinge portion 220 is a hollow structure with an opening at least one end, and the second hinge portion 320 extends into the first hinge portion 220.

In the present embodiment, the front side frame 110, the rear side frame 120, the first foldable bottom frame 130 and the second foldable bottom frame 140 are all made of metal materials.

Referring to FIGS. 3-4, the top of the first support rod 200 is provided with a first bearing block 230. The top of the second support rod 300 is provided with a second bearing block 330. The first bearing block 230 and the second bearing block 330 are configured for bearing the first foldable bottom frame 130 and the second foldable bottom frame 140. Specifically, the first bearing block 230 and the second bearing block 330 function as cushion against the direct impingement of the first foldable bottom frame 130 and the second foldable bottom frame 140 made of the metal materials on the front side frame 110 and the rear side frame 120 made of the metal materials when the foldable trolley is required to be in an unfolded configuration, and thus the service life of the foldable trolley is prolonged. Additionally, due to the existence of the first sleeve 210 and the second sleeve 310, or for other considerations, the first foldable bottom frame 130 and the second foldable bottom frame 140 will have a preset spacing with the first support rod 200 and the second support rod 300, such that the first support rod 200 and the second support rod 300 unable to directly support the first foldable bottom frame 130 and the second foldable bottom frame 140. However, a first bearing block 230 and a second bearing block 330 are arranged in the present disclosure, and the height of the first bearing block 230 and the second bearing block 330 is adapted for the preset spacing to enable the first bearing block 230 and the second bearing block 330 to directly contact with the first foldable bottom frame 130 and the second foldable bottom frame 140 when the foldable trolley is in an unfolded configuration, such that the first support rod 200 and the second support rod 300 can provide the first foldable bottom frame 130 and the second foldable bottom frame 140 with reliable support via the first bearing block 230 and the second bearing block 330.

In the present embodiment, the first bearing block 230 and the second bearing block 330 are made of plastic materials.

Referring to FIGS. 3-4, two first convex piece 231 are arranged spaced apart on the top of the first bearing block 230. The first foldable bottom frame 130 is provided with a first locating rod 131, which can be clamped between the two first convex piece 231 when the first foldable bottom frame 130 and the second foldable bottom frame 140 are in an unfolded configuration.

Referring to FIGS. 3-4, two second convex piece 331 are arranged spaced apart on the top of the second bearing block 330. The second foldable bottom frame 140 is provided with a second locating rod 141, which can be clamped between the two second convex piece 331 when the first foldable bottom frame 130 and the second foldable bottom frame 140 are in an unfolded configuration. Specifically, the arrangement of the first convex piece 231 and the first locating rod 131, the second convex piece 331 and the second locating rod 141 enables the reliable locating of the first foldable bottom frame 130 and the second foldable bottom frame 140 when the foldable trolley is in an unfolded configuration. After the foldable trolley is unfolded, it is only required to gently press the first foldable bottom frame 130 and the second foldable bottom frame 140 to allow the first locating rod 131 to be clamped between the two first convex pieces 231, and the second locating rod 141 to be clamped between the two second convex pieces 331.

In the present embodiment, the first convex piece 231 and the second convex piece 331 are made of plastic materials. Specifically, since the first bearing block 230 and the second bearing block 330 as well as the first convex piece 231 and the second convex piece 331 are all made of plastic materials, when the foldable trolley is in the unfolded configuration, the first foldable bottom frame 130 and the second foldable bottom frame 140 are supported and positioned by the first convex piece 231 and the second convex piece 331 to avoid the direct impingement of the first foldable bottom frame 130 and the second foldable bottom frame 140 of the metal materials on the front side frame 110 and the rear side frame 120 of the metal materials, and thus prolonging the service life of the foldable trolley.

Referring to FIG. 3, the front side frame 110 includes a front upper frame 111 and a front lower frame 112 which are detachably connected. The first support rod 200 is rotatably connected with the front lower frame 112. The rear side frame 120 includes a rear upper frame 121 and a rear lower frame 122 which are detachably connected, and the second support rod 300 is rotatably connected with the rear lower frame 122.

Referring to FIG. 3, the front upper frame 111 includes a first top rod 1111 and two first vertical rods 1112 arranged spaced apart beneath the first top rod 1111. The front lower frame 112 includes a first bottom rod 1121 and two first vertical pipes 1122 arranged spaced apart above the first bottom rod 1121, and the two first vertical rods 1112 can be detachably inserted into the two first vertical pipes 1122 to achieve the detachable connection between the front upper frame 111 and the front lower frame 112, and the rotatable connection between the first support rod 200 and the first vertical pipe 1122.

Referring to FIG. 3, the rear upper frame 121 includes a second top rod 1211 and two second vertical rods 1212 which are arranged spaced apart beneath the second top rod 1211, the rear lower frame 122 includes a second bottom rod 1221 and two second vertical pipes 1222 arranged spaced apart above the second bottom rod 1221, and the two second vertical rods 1212 can be detachably inserted into the two second vertical pipes 1222 to achieve the detachable connection between the rear upper frame 121 and the rear lower frame 122, and rotatable connection between the second support rod 300 and the second vertical pipe 1222. Specifically, on one aspect, the front side frame 110 is detachable, which can further reduce the occupied space; on the other aspect, the front upper frame 111 and/or the rear upper frame 121 can be removed to receive the items with a length larger than that of the foldable frame 100.

In the present embodiment, the first sleeve 210 is sleeved in the first vertical pipe 1122, and the second sleeve 310 is sleeved in the second vertical pipe 1222.

Referring to FIG. 1, the foldable trolley further includes a handle assembly 700, and the handle assembly 700 is rotatably connected with a front side frame 110 or a rear side frame 120. The handle assembly 700 is arranged to facilitate the transfer of the foldable trolley by the user. The handle assembly 700 is rotatably connected with the front side frame 110 or the rear side frame 120, to enable the user to rotate the handle assembly 700 according to the requirement when holding the handle assembly 700, which makes the holding of the user at an angle of the most comfortable posture.

In the present embodiment, the handle assembly 700 is rotatably connected with the first bottom rod 1121 of the front side frame 110.

The handle assembly 700 is telescopic along its own axis, such that users of different heights can operate the trolley in a comfortable posture by adjusting the telescopic handle assembly 700, or the user can adjust the space between himself and the foldable frame 100 according to the personal preference.

Referring to FIG. 1, the handle assembly 700 includes a handle 710, a first rod component 720 and a second rod component 730, where the first rod component 720 and the second rod component 730 are sleevedly connected with each other. The handle 710 is arranged on the first rod component 720. The second rod component 730 is rotatably connected with the front side frame 110 or the rear side frame 120, and the first rod component 720 can move along its own axial direction to change the sheath length of the first rod component 720 relative to the second rod component 730.

Specifically, the first rod component 720 moves upwards along its own axis, and the first rod component 720 extends out by a longer length relative to the second rod component 730, as a result, the handle assembly 700 is elongated, and conversely, the handle assembly 700 is shortened.

In the present embodiment, the handle assembly 700 is rotatably connected with the first bottom rod 1121 of the front side frame 110.

Referring to FIG. 1, a clamping component 11111 is arranged on the first top rod 1111 of the front side frame 110, and the clamping component 11111 is used for clamping the first rod component 720 or the second rod component 730. When the handle assembly 700 is not used, the first rod component 720 or the second rod component 730 is clamped on the clamping component 11111, as a result, the immobilization of the handle assembly 700 relative to the front side frame 110 is achieved.

Referring to FIG. 1, the number of the first rotating wheel 400 is two, and the two first rotating wheels 400 are rotatably arranged spaced apart at the bottom of the front side frame 110. The number of the second rotating wheel 500 is two, and the two second rotating wheels 500 are arranged spaced apart at the bottom of the rear side frame 120.

Along the length direction of the foldable trolley, the two first rotating wheels 400 and the two second rotating wheels 500 are not collinear, such that when the whole foldable trolley is folded, the four rotating wheels will not interfere with each other.

The first rotating wheel 400 is a caster.

Referring to FIG. 1, the foldable trolley further includes a rotating wheel mounting component 800 and a connecting column 900. The first rotating wheel 400 is rotatably arranged in the rotating wheel mounting component 800. The rotating wheel mounting component 800 is rotatably arranged beneath the connecting column 900. The axis of the first rotating wheel 400 is perpendicular to the axis of the connecting column 900, and the connecting column 900 is welded to the first bottom rod 1121 of the front side frame 110. Specifically, the rotating wheel can rotate around its own axis relative to the rotating wheel mounting component 800, and the rotating wheel can also rotate around the axis of the connecting column 900 together with the rotating wheel mounting component 800, making the first rotating wheel 400 as a caster.

Referring to FIG. 1, the number of the rotating wheel mounting component 800 and the number of the connecting column 900 are the same as that of the first rotating wheel 400. The rotating wheel mounting components 800 and the connecting columns 900 are in one-to-one correspondence with the first rotating wheels 400.

Described above are only preferred embodiments of the present disclosure, which are not intended to limit the scope of the present disclosure. It should be understood that various modifications, equivalent replacements and variations made by those skilled in the art without departing from the spirit of the disclosure, and the direct or indirect application of equivalents of the device provided herein in other related technical fields shall fall within the scope of the disclosure defined by the appended claims.

What is claimed is:

1. A foldable trolley, comprising:
a foldable frame;
a first support rod;
a second support rod hingedly connected with the first support rod;
a first rotating wheel; and
a second rotating wheel;
wherein the foldable frame comprises a front side frame, a rear side frame, a first foldable bottom frame and a second foldable bottom frame; the first foldable bottom frame is hingedly connected with the second foldable bottom frame; the front side frame is arranged at an end of the first foldable bottom frame away from the second foldable bottom frame; the rear side frame is arranged at an end of the second foldable bottom frame away from the first foldable bottom frame; the first foldable bottom frame is hingedly connected with the front side frame, and the second foldable bottom frame is hingedly connected with the rear side frame; and the first foldable bottom frame and the second foldable bottom frame are able to be folded or unfolded;
an end of the first support rod away from the second support rod is rotatably connected with the front side frame; an end of the second support rod away from the first support rod is rotatably connected with the rear side frame; the first support rod and the second support rod are located beneath the first foldable bottom frame and the second foldable bottom frame; and the first support rod and the second support rod are configured to support the first foldable bottom frame and the second foldable bottom frame;
the first rotating wheel is rotatably arranged at a bottom of the front side frame; and
the second rotating wheel is rotatably arranged at a bottom of the rear side frame.

2. The foldable trolley according to claim 1, wherein an axis of a hinged connection between the first support rod and the second support rod is perpendicular to the first foldable bottom frame in an unfolded configuration.

3. The foldable trolley according to claim 1, wherein the end of the first support rod away from the second support rod is provided with a first sleeve; the first sleeve is rotatably sleeved on the front side frame; the end of the second support rod away from the first support rod is provided with a second sleeve; and the second sleeve is rotatably sleeved on the rear side frame.

4. The foldable trolley according to claim 1, wherein a top of the first support rod is provided with a first bearing block, and a top of the second support rod is provided with a second bearing block; and the first bearing block and the second bearing block are configured for bearing the first foldable bottom frame and the second foldable bottom frame.

5. The foldable trolley according to claim 4, wherein two first convex pieces are arranged spaced apart on a top of the first bearing block; the first foldable bottom frame is provided with a first locating rod; and the first locating rod is configured to be clamped between the two first convex pieces when the first foldable bottom frame is unfolded with respect to the second foldable bottom frame; and/or
two second convex pieces are arranged spaced apart on a top of the second bearing block; the second foldable bottom frame is provided with a second locating rod; and the second locating rod is configured to be clamped between the two second convex pieces when the first foldable bottom frame is unfolded with respect to the second foldable bottom frame.

6. The foldable trolley according to claim 1, wherein the front side frame comprises a front upper frame and a front lower frame detachably connected to the front upper frame; the first support rod is rotatably connected with the front lower frame; and
the rear side frame comprises a rear upper frame and a rear lower frame detachably connected to the rear upper frame, and the second support rod is rotatably connected with the rear lower frame.

7. The foldable trolley according to claim 6, wherein the front upper frame comprises a first top rod and two first vertical rods; the two first vertical rods are arranged spaced apart beneath the first top rod; the front lower frame comprises a first bottom rod and two first vertical pipes; the two first vertical pipes are arranged spaced apart above the first bottom rod; the two first vertical rods are configured to be detachably inserted into the two first vertical pipes, respectively, so as to achieve detachable connection between the front upper frame and the front lower frame; and the first support rod is rotatably connected to the two first vertical pipes; and
the rear upper frame comprises a second top rod and two second vertical rods; the two second vertical rods are arranged spaced apart beneath the second top rod; the rear lower frame comprises a second bottom rod and two second vertical pipes; the two vertical pipes are arranged spaced apart above the second bottom rod; the two second vertical rods are configured to be detachably inserted into the two second vertical pipes, respectively, so as to achieve detachable connection between the rear upper frame and the rear lower frame; and the second support rod is rotatably connected to the two second vertical pipes.

8. The foldable trolley according to claim 1, wherein the foldable trolley further comprises a handle assembly, and the handle assembly is rotatably connected with the front side frame or the rear side frame.

9. The foldable trolley according to claim 8, wherein the handle assembly is configured to be telescopic along its own axis.

10. The foldable trolley according to claim 9, wherein the handle assembly comprises a handle, a first rod component and a second rod component; the first rod component and the second rod component are sleevedly connected; the handle is arranged on the first rod component; the second rod component is rotatably connected with the front side frame or the rear side frame; and the first rod component is configured to move along its own axial direction to change a length of the first rod component sleeved in the second rod component.
